(19) United States
(12) Patent Application Publication
(10) Pub. No.: US 2025/0371010 A1
(43) Pub. Date: Dec. 4, 2025

(54) METHOD AND APPARATUS FOR PROVIDING INTERACTIVE AGENT BY USING CALL SEQUENCE

(71) Applicant: 42dot Inc., Seoul (KR)

(72) Inventors: Seong Han Ryu, Seongnam (KR); Cheong Jae Lee, Seongnam (KR); Mi Rye Lee, Seongnam (KR); Soon Choul Kwon, Seongnam, Gyeonggi-do (KR); Yeon Soo Lim, Seongnam (KR); Sung Jun Han, Seongnam (KR); Aren Siekmeier, Seongnam (KR)

(21) Appl. No.: 19/303,068

(22) Filed: Aug. 18, 2025

(30) Foreign Application Priority Data
Aug. 20, 2024 (KR) 10-2024-0111139

(51) Int. Cl. G06F 16/2453; G06F 16/334

(52) U.S. Cl. CPC G06F 16/24542; G06F 16/334

(57) ABSTRACT

Provided are a method and apparatus for providing an interactive agent by using a call sequence. The method of providing an interactive agent by using a call sequence includes generating a call sequence based on an input text of a vehicle passenger, by using a first language model that is pre-trained, obtaining information of interest by executing the call sequence, and generating an output text corresponding to the input text, based on the information of interest, by using a second language model that is pre-trained, wherein the call sequence includes a plurality of calls.

### CROSS-REFERENCE TO RELATED APPLICATION

This application is based on and claims priority under 35 U.S.C. § 119 to Korean Patent Application No. 10-2024-0111139, filed on Aug. 20, 2024, in the Korean Intellectual Property Office, the disclosure of which is incorporated by reference herein in its entirety.

### BACKGROUND

### 1. Field

The present disclosure relates to a method and apparatus for providing an interactive agent by using a call sequence.

### 2. Description of the Related Art

The automobile industry has been developing rapidly in recent years, and vehicles are evolving from a simple means of transportation to a platform that includes various digital functions. In particular, vehicle infotainment systems have evolved from simple radios and cassette players to systems that provide a variety of functions, including multimedia, navigation, Internet-based services, and smartphone connectivity. These systems are becoming essential for improving driver convenience and safety.

Additionally, advances in natural language processing (NLP) technology have made it possible to provide services that provide natural dialogues between a human user and an artificial intelligence agent. These interactive artificial intelligence services are being integrated into various technology fields, including the automotive industry, in the form of chatbots or voice recognition assistants.

In particular, the importance of task-oriented dialogue systems that aim to satisfy users' specific needs using artificial intelligence agents is emerging. An artificial intelligence agent processes a user's input with a large language model (LLM) and generates a response that matches the user's purpose. However, if the user's purpose cannot be satisfied with only the internal knowledge of the language model, information collection from outside the language model is necessary, such as through application programming interface (API) calls.

In the related art, information is collected by performing input/output processes of a language model multiple times to process complex user input and generating and executing a necessary call for each input/output process. However, according to the related art, there was inefficiency in terms of execution time and cost in that the input/output process of the language model was required multiple times for call generation. In addition, the related art relies on local optimization rather than global optimization in that the calls required to generate a response are generated sequentially rather than all at once, which results in a problem in that the possibility of the response meeting the user's purpose is relatively low.

The background technology described above is technical information that the inventor possessed for deriving the present disclosure or obtained in the process of deriving the present disclosure, and cannot necessarily be said to be publicly known technology disclosed to the general public prior to the application for the present disclosure.

### SUMMARY

The present disclosure provides a method and apparatus for providing an interactive agent by using a call sequence. The objectives to be solved by the present disclosure are not limited to the objectives mentioned above, and other objectives and advantages of the present disclosure that are not mentioned may be understood by the following description and will be clearly understood by the embodiments of the present disclosure. In addition, it will be appreciated that the objectives and advantages to be solved by the present disclosure may be realized by the means and combinations thereof indicated in the claims.

However, the above objectives are examples, and the scope of the disclosure is not limited by the above objectives.

Additional aspects will be set forth in part in the description which follows and, in part, will be apparent from the description, or may be learned by practice of the presented embodiments of the disclosure.

According to an aspect of the present disclosure, a method of providing an interactive agent by using a call sequence, includes generating a call sequence based on an input text of a vehicle passenger by using a first language model that is pre-trained, obtaining information of interest by executing the call sequence, and generating an output text corresponding to the input text, based on the information of interest, by using a second language model that is pre-trained, wherein the call sequence includes a plurality of calls.

According to another aspect of the present disclosure, an apparatus for providing an interactive agent by using a call sequence, includes a communication module configured to perform communication, a memory storing at least one program, and a processor configured to operate by executing the at least one program, wherein the processor is further configured to generate a call sequence based on an input text of a vehicle passenger, by using a first language model that is pre-trained, control the communication module to obtain information of interest by executing the call sequence, and generate an output text corresponding to the input text based on the information of interest, by using a second language model that is pre-trained, wherein the call sequence includes a plurality of calls.

According to another aspect of the present disclosure, a computer-readable recording medium having recorded thereon a program for causing the method described above to execute on a computer is provided.

Other aspects, features and advantages other than those described above will become apparent from the following drawings, claims and detailed description of the invention.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a system including a generation device;

FIG. 2 is an example of an operating method of a generation device operating to provide an interactive agent by using a call sequence;

FIG. 3 is a diagram for describing a generation device including a first generation unit, an execution unit, and a second generation unit;

FIG. 4 is a diagram schematically illustrating a process of generating a call sequence based on input text;

FIG. 5 is a diagram illustrating a process of generating a first input prompt as input to a first language model, based on input text;

FIG. 6 is a diagram for describing a process of generating a call sequence, based on an output of the first language model;

FIG. 7 is a diagram for describing a process of structuring the output of the first language model;

FIG. 8 is a diagram for describing various data used in generating a call sequence;

FIG. 9 is a diagram for describing a process of generating output text by using a second language model;

FIG. 10 is an example of an operating method of a generation device operating to visualize a call sequence of an interactive agent;

FIG. 11 is a diagram for describing unit executions included in a call sequence;

FIG. 12 is a diagram for describing visual elements corresponding to unit executions;

FIG. 13 is a diagram illustrating an interface that displays a hierarchical structure of a call sequence;

FIG. 14 is a diagram illustrating a process in which an interface displaying a call sequence interacts with a user; and

FIG. 15 is a block diagram of an apparatus according to an embodiment.

### DETAILED DESCRIPTION

The advantages and features of the present disclosure and the methods for achieving the same will become apparent by referring to the embodiments described in detail together with the accompanying drawings. However, the present disclosure is not limited to the embodiments presented below, but may be implemented in various different forms, and should be understood to include all transformations, equivalents, or substitutes included in the spirit and technical scope of the present disclosure. The examples set forth below are provided to ensure that the present disclosure is complete and will fully convey the scope of the present disclosure to those skilled in the art to which the present disclosure pertains. In the description of the present disclosure, certain detailed descriptions of related art are omitted when it is deemed that they may unnecessarily obscure the essence of the present disclosure.

The terms used in the present specification are merely used to describe particular embodiments, and are not intended to limit the present disclosure. Unless otherwise defined, all terms used herein have the same meaning as commonly understood by one of ordinary skill in the art to which the present disclosure belongs.

In this specification, singular expressions include plural expressions unless the context clearly indicates otherwise. Furthermore, it should be understood that terms such as “include” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Additionally, terms including ordinal numbers, such as “first” or “second,” used herein may be used to describe various components, but the components should not be limited by the terms. The terms are used solely to distinguish one component from another.

The appearances of phrases such as “in an embodiment,” “according to an embodiment,” “relating to an embodiment,” or “according to an implementation of an embodiment” in this specification are not necessarily all referring to the same embodiment. Additionally, throughout the specification, the term “embodiment” is an arbitrary distinction used to facilitate the description of the present disclosure, and each embodiment is not necessarily exclusive of the others. For example, configurations mentioned for the purpose of describing an embodiment may be applied and/or implemented in other embodiments, and may be applied and/or implemented with modifications without departing from the scope of the present disclosure.

Some embodiments of the present disclosure may be described in terms of functional block components and various processing steps. Such functional blocks may be realized by any number of hardware and/or software components configured to perform specified functions. For example, the functional blocks of the present disclosure may be implemented by one or more microprocessors or by circuit configurations for a predetermined function.

For example, the functional blocks of the present disclosure may be implemented in various programming or scripting languages. The functional blocks may be implemented as algorithms that execute on one or more processors. Furthermore, the present disclosure may employ any number of techniques of the related art, for electronics configuration, signal processing and/or control, data processing and the like. Terms such as “mechanism”, “element”, “means”, and “configuration” may be used broadly and are not limited to mechanical and physical configurations. Additionally, terms such as “-unit”, “-module”, etc. refer to a unit that processes at least one function or operation, which may be implemented by hardware or software, or by a combination of hardware and software.

Furthermore, the connecting lines, or connectors shown in the various figures presented are intended to represent examples of functional relationships and/or physical or logical couplings between the various elements. It should be noted that many alternative or additional functional relationships, physical connections or logical connections may be present in a practical device.

Additionally, some components in the drawings may be illustrated with somewhat exaggerated size or proportions. Additionally, components illustrated in one drawing may not be illustrated in another drawing.

Hereinafter, a “vehicle” may refer to any type of transportation that has a mechanism and is used to move people or things, such as a car, bus, motorcycle, kickboard, or truck.

The present disclosure will be described in detail with reference to the attached drawings below.

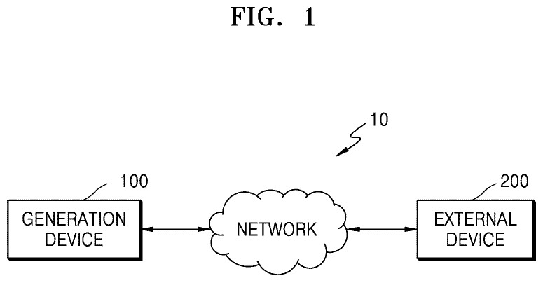

FIG. 1 is a schematic diagram of a system including a generation device.

Referring to FIG. 1, a system 10 may include a generation device 100. The generation device 100 of the present disclosure refers to an electronic device used to provide an interactive agent to a user. In an embodiment, the generation device 100 may include an apparatus that provides an interactive agent by using a call sequence, and may include an apparatus that visualizes the call sequence of the interactive agent. The interactive agent may include an interactive artificial intelligence agent used in an interactive artificial intelligence service.

In the present disclosure, an interactive artificial intelligence agent is an interactive interface that provides an interactive artificial intelligence service to a user by using an artificial intelligence model. The interactive artificial intelligence service refers to an artificial intelligence-based service that allows machines and users to communicate in natural language. The interactive artificial intelligence service may be implemented as a chatbot, a virtual assistant, or a customer support system that answer users' questions or process users' commands.

In an embodiment, providing an interactive agent may include providing an interactive interface of an interactive artificial intelligence service to a user and thereby providing a response from the interactive agent with regard to user input.

The system 10 according to an embodiment may include a vehicle system, and the generation device 100 may be implemented as a component of the vehicle system. The vehicle system may be implemented by at least one electronic device used to provide various functions and/or information, such as interactive artificial intelligence services, to a user riding in a vehicle.

In an embodiment, the generation device 100 may obtain an input from a user riding in a vehicle (e.g., voice utterance or text input) and generate a response from the interactive agent based on the obtained input. The generation device 100 may provide a response from an interactive artificial intelligence agent to a user by displaying a vehicle interface including a response, through a display device (not shown) that constitutes a vehicle system. The vehicle interface may include a graphical user interface (GUI).

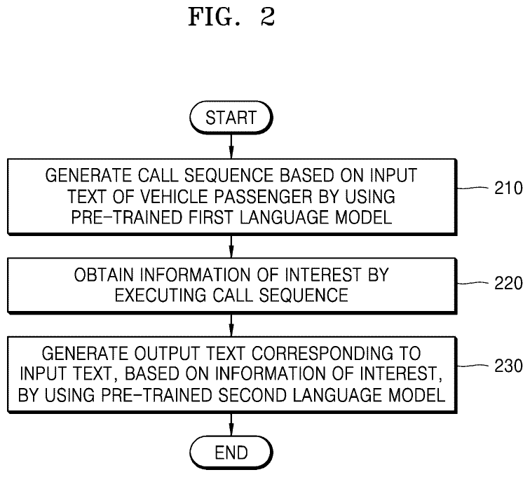

A process by which the generation device 100 generates dialogue information will be described later in detail with reference to FIGS. 2 to 9, etc.

A display device according to an embodiment refers to a device that displays to a user an interaction between the user and an interactive agent. In an embodiment, the display device may include a device that visually displays a response from the interactive agent, which is generated by the generation device 100. According to an embodiment, the display device may be installed in a location visible to a user, such as around the driver's seat of a vehicle, to visually display interaction between the user and an interactive agent.

For example, the display device may include, but is not limited to, a central information display mounted on the vehicle, a cluster display, and/or a head-up display.

The generation device 100 according to an embodiment may be implemented as a device mounted inside a vehicle to provide an interactive agent, a server device managing an interactive artificial intelligence service outside the vehicle, a device portable by a user, or a combination thereof.

For example, the generation device 100 may be implemented as, but is not limited to, a computing device mounted on a vehicle, a server device of an entity that supplies or manages vehicle software, a user's smartphone, a tablet personal computer (PC), a global positioning system (GPS) device, or other mobile or non-mobile computing device.

In an embodiment, the generation device 100 may obtain a user input and generate a response based on the user input. For example, the generation device 100 may generate a response corresponding to a user input, based on the user input, by using an artificial intelligence model. The generation device 100 may use information accessible within a vehicle system and/or external information, in the process of generating a response.

In an embodiment, the system 10 may further include an external device 200. The external device 200 of the present disclosure refers to a device that provides external information when the generation device 100 is not able to generate a response to user input, using only information accessible within the vehicle system.

In an embodiment, the external information may include, but is not limited to, various search results, information about real-time traffic flow, information about specific locations, and/or weather information.

In an embodiment, the generation device 100 may exchange information by communicating with the external device 200 by using a network. Additionally, the components of the vehicle system including the generation device 100 may exchange information by performing communication with each other using a network.

The network may be a comprehensive data communication network that allows different entities to communicate smoothly with each other, and include wired Internet, wireless Internet, and mobile wireless communication networks. For example, the network may include a Local Area Network (LAN), a Wide Area Network (WAN), a Value Added Network (VAN), a mobile radio communication network, a satellite communication network, and combinations thereof.

The wired communication may include Ethernet and Fiber Optic Networks. Additionally, the wireless communication may include, but is not limited to, wireless LAN (Wi-Fi), Bluetooth, Bluetooth low energy, ZigBee, Wi-Fi Direct (WFD), ultra-wideband (UWB), infrared communication (IrDA, infrared Data Association), Near Field Communication (NFC), etc.

For example, the generation device 100 may exchange information with the external device 200 by using wireless communication, and the components of the vehicle system such as the generation device 100 and a display device may exchange information by using wired communication, but are not limited thereto.

In an embodiment, the generation device 100 may transmit a response of the interactive agent and/or a vehicle interface including the response to a display device by performing communication using a network, and the display device may display data obtained from the generation device 100.

Additionally, in an embodiment, the generation device 100 may obtain various external information from the external device 200 to satisfy the user's purpose predicted from user input by performing communication using a network.

FIG. 2 is an example of an operating method of a generation device operating to provide an interactive agent by using a call sequence.

Referring to FIG. 2, in operation 210, the generation device 100 may generate a call sequence, based on an input text of a vehicle passenger, by using a pre-trained first language model. The call sequence may include a plurality of calls.

In an embodiment, a call sequence may include a plurality of calls having a nested structure.

In an embodiment, the generation device 100 may generate a call sequence based on input text and a dialogue history of a passenger.

In an embodiment, the generation device 100 may preprocess input text based on at least one of entity search, dialogue example search, and prompt template application.

For example, the generation device 100 may generate a first search result including an entity corresponding to at least one string constituting input text, by using a previously generated entity database. Additionally, the generation device 100 may generate a second search result including at least one dialogue example having a similarity higher than or equal to a threshold, with respect to the input text, by using a previously generated dialogue example database.

Then, the generation device 100 may determine at least one call used in at least one dialogue example included in the second search result as a target call. Additionally, the generation device 100 may generate a first input prompt for the first language model by applying a previously generated first prompt template to the input text, the first search result, and the target call.

In an embodiment, the generation device 100 may post-process an output of the first language model based on at least one of parsing and slot normalization.

For example, the generation device 100 may generate a structured output representing the structure of a string by parsing the output of the first language model, which is a string representation. Thereafter, the generation device 100 may generate a call sequence by changing at least one string included in the structured output, into a normalized expression, by using a previously generated slot normalization database.

In operation 220, the generation device 100 may obtain information of interest by executing the call sequence.

In an embodiment, the generation device 100 may obtain information of interest by sequentially executing at least some of a plurality of calls in a preset order, or by executing at least some of the plurality of calls in parallel.

For example, the generation device 100 may obtain information of interest by sequentially executing a plurality of calls, based on a depth-first search technique.

In operation 230, the generation device 100 may generate an output text corresponding to the input text, based on the information of interest by using a pre-trained second language model.

In an embodiment, the call sequence may include all calls for generating output text.

In an embodiment, the generation device 100 may generate output text, based on input text and information of interest.

In an embodiment, the generation device 100 may update the dialogue history by adding input text to the dialogue history. Thereafter, the generation device 100 may generate output text based on the updated dialogue history and the information of interest.

In an embodiment, the generation device 100 may generate a second input prompt for the second language model by applying a previously generated second prompt template to the updated dialogue history and the information of interest.

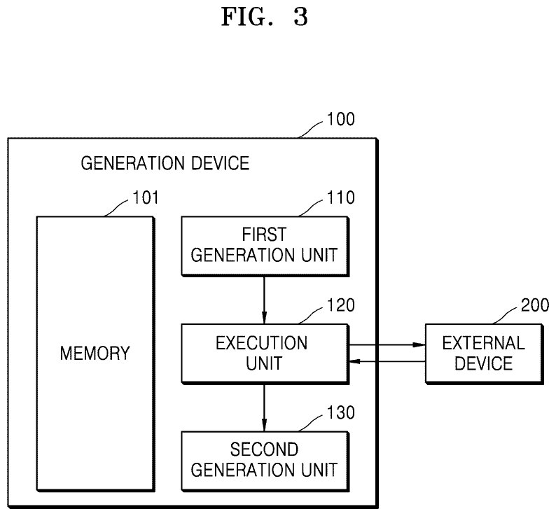

FIG. 3 is a diagram for describing a generation device including a first generation unit, an execution unit, and a second generation unit.

Referring to FIG. 3, the generation device 100 may include a memory 101, a first generation unit 110, an execution unit 120, and a second generation unit 130.

In an embodiment, the generation device 100 may obtain input text from a user, such as a vehicle passenger. For example, the generation device 100 may obtain user input, such as voice utterance and/or text input, from a user through an input interface provided in the vehicle, such as a microphone, keypad, and/or touchscreen.

In an embodiment, the generation device 100 may directly obtain input text in the form of text input. In another embodiment, the generation device 100 may obtain input text by converting a voice signal corresponding to a voice utterance into text by using a voice recognition model to generate the input text.

In an embodiment, the first generation unit 110 may generate a call sequence, based on input text. The execution unit 120 may obtain information of interest by executing a call sequence generated from the first generation unit 110. The second generation unit 130 may generate output text corresponding to input text based on information of interest.

In an embodiment, the first generation unit 110 may generate a call sequence, based on input text of a user, by using a pre-trained first language model. The first language model may include a pre-trained language model to perform natural language processing (NLP) tasks. The first language model may be implemented using various language models such as Bidirectional Encoder Representations from Transformers (BERT), Generative Pre-trained Transformer (GPT), Transformer, Long Short-Term Memory (LSTM), and extreme Language Net (XLNet), but is not limited thereto. The first language model according to an embodiment may include a large language model (LLM) trained based on a large text dataset.

In the present disclosure, a call sequence refers to a set of commands including at least one call. In an embodiment, a call sequence may include a plurality of calls. A call according to an embodiment may include, in order for the generation device 100 to generate a response corresponding to input text, obtaining various data from the memory 101 of the generation device 100, another device within a vehicle system, or the external device 200, or requesting a predetermined task from the memory 101, another device within the vehicle system, or the external device 200.

As an example, the call may include calling an application programming interface (API) endpoint of the external device 200 to obtain data from the external device 200. As another example, the call may include a system command call to control at least a portion of a hardware or software component of a vehicle system, which includes the generation device 100. As another example, the call may include, but is not limited to, a database query call that executes a query to retrieve or modify information from a database accessible by the generation device 100.

In an embodiment, the call may include a request for an action to accomplish various purposes, such as searching for a particular search term, checking if a particular restaurant sells a particular menu, calling a particular person, scheduling an alarm, opening and closing a vehicle's windows, or turning the vehicle's air conditioning on and off.

In an embodiment, the execution unit 120 may obtain information of interest by executing a call sequence. In the present disclosure, the information of interest refers to information required to generate a response of an interactive agent corresponding to input text. In an embodiment, the information of interest may include a particular type of information determined by the first generation unit 110 based on input text.

Additionally, in an embodiment, the information of interest may include external information obtained from the external device 200. According to an embodiment, external information obtained from the external device 200 may include, but is not limited to, text in a structured format (e.g., JavaScript Object Notation (JSON) or extensible Markup Language (XML)).

For example, if input text of a vehicle passenger indicates ‘Tell me the current weather here’, the first generation unit 110 may determine, as information of interest required to generate a response, location information of the vehicle and the current weather information at the corresponding location, and generate a call sequence for obtaining the location information of the vehicle and the current weather information at the corresponding location.

As an example, the first generation unit 110 may generate a call sequence including a first call for requesting the location information of the vehicle from a location sensor within the vehicle system or a first external device that provides the location information of the vehicle, in order to obtain the location information of the vehicle. Additionally, the first generation unit 110 may generate a call sequence that further includes a second call for requesting weather information corresponding to the current location of the vehicle from a second external device providing weather information in order to obtain weather information of the current location.

Thereafter, the execution unit 120 may obtain the location information of the vehicle and the current weather information of the corresponding location as the information of interest by executing the call sequence generated from the first generation unit 110.

In an embodiment, the execution unit 120 may obtain information of interest by sequentially executing at least some of the plurality of calls in a preset order or by executing at least some of the plurality of calls in parallel.

In an embodiment, if there is a data dependency among certain calls that constitute the plurality of calls, the execution unit 120 may obtain information of interest by sequentially executing the certain calls in a preset order in order to utilize the results of previous calls in a next call.

For example, if the input text of the vehicle passenger indicates ‘Tell me the current weather here’, the current location information of the vehicle may be first obtained and then weather information may be retrieved based on the identified location, and thus, the execution unit 120 may execute a call for location information retrieval before a call for weather information retrieval.

In an embodiment, the execution unit 120 may obtain information of interest by sequentially executing a plurality of calls based on a depth-first search technique. Depth-first search indicates searching all nodes by going as deep as possible from the node where the search begins and searching child nodes until there are no more child nodes, and then returning to the previous step and searching along a different path when there are no more child nodes.

That is, in an embodiment, the execution unit 120 may obtain information of interest by executing all calls constituting a call sequence having a tree structure, in the order of depth-first search.

For example, if the input text of the vehicle passenger indicates ‘Tell me the current weather here’, a start node may correspond to a vehicle location retrieval, and a child node of the start node may correspond to a position-based weather information retrieval. The execution unit 120 may first execute a call for vehicle location retrieval, and then execute a call for location-based weather information retrieval, in the order in which child nodes are searched from the start node.

In another embodiment, if there is no data dependency between certain calls that constitute a plurality of calls, for efficient work, the execution unit 120 may obtain information of interest by executing certain calls in parallel.

For example, if the input text of the vehicle passenger indicates ‘Tell me today's weather and news headlines’, as there is no data dependency between weather information retrieval and news information retrieval, the execution unit 120 may execute a call for weather information retrieval and a call for news information retrieval in parallel, regardless of the order.

In an embodiment, the second generation unit 130 may generate output text corresponding to input text based on information of interest by using a pre-trained second language model. The second language model may include, but is not limited to, a language model identical to the first language model.

In an embodiment, the second language model may include a pre-trained language model to perform natural language processing tasks. The second language model may be implemented using various language models such as such as BERT, GPT, Transformer, LSTM, and XLNet, but is not limited thereto. The second language model according to an embodiment may include a LLM trained based on a large text dataset.

The call sequence may include all calls made by the second language model to generate output text.

In an embodiment, instead of repeating the input/output process of the first language model multiple times, the first generation unit 110 may generate a call sequence that includes all calls necessary for generating output text, by using a single input/output process of the first language model. Next, the execution unit 120 may obtain information of interest by executing all calls included in the call sequence, and the second generation unit 130 may generate output text based on the information of interest.

According to an embodiment of the present disclosure, compared to a method of generating a next call to be executed, based on information obtained after executing one call, the number of input/output processes of a language model used to generate a call may be reduced, and accordingly, the time taken to generate output text from input text may be reduced, and furthermore, unnecessary waste of computing resources may be prevented.

In addition, the method of generating a next call to be executed, based on the information obtained after executing one call, may have relatively low accuracy of the output text, since the process of generating each call is based on local optimum. On the other hand, according to the embodiment described above, the accuracy of the output text may be improved by generating a call sequence based on a global optimum through a single input/output process of the language model.

The memory 101 may be hardware that stores various data processed within the generation device 100. The memory 101 may store various programs used for the operation, processing and control of the first generation unit 110, the execution unit 120, and the second generation unit 130, including program codes for implementing the first language model or the second language model. Additionally, the memory 101 may store various data used or generated by the generation device 100, such as input text, a call sequence, and output text.

In an embodiment, the generation device 100 may generate a dialogue history based on input text. A dialogue history according to an embodiment may include at least one input text and a response corresponding to each input text. For example, if the generation device 100 generates a first response corresponding to a first input text, the generation device 100 may store the obtained first input text and the generated first response in the memory 101.

In an embodiment, the first generation unit 110 may generate a call sequence based on input text and a dialogue history of a passenger. For example, the first generation unit 110 may generate a call sequence based on a dialogue history including the first input text and the first response, together with a second input text. That is, the first generation unit 110 may generate a call sequence suitable for a user by considering a dialogue pattern with the user by referring to the dialogue history in addition to the input text.

For example, the dialogue history may include multiple input texts indicating ‘Tell me the weather’, a response to the input text that includes weather information based on the current location, and input text indicating ‘Tell me the weather at my work location, not my current location’. The first generation unit 110 may generate a call sequence for retrieving work location-based weather information for an input text indicating ‘tell me the weather’ by generating a call sequence by reflecting a previous dialogue context and dialogue pattern shown in the dialogue history.

In an embodiment, the generation device 100 may update the dialogue history by adding input text to the dialogue history. For example, if the dialogue history including the first input text and the first response is stored in the memory 101, the generation device 100 may update the dialogue history by adding the second input text to the dialogue history based on the obtaining of the second input text.

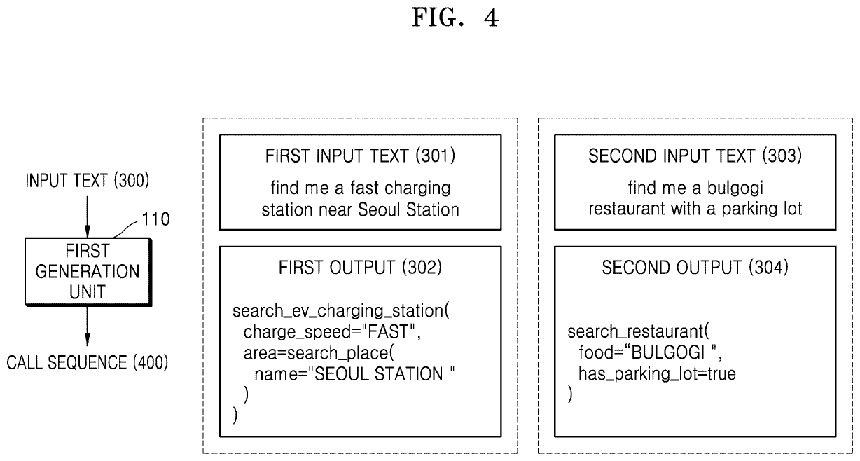

FIG. 4 is a diagram schematically illustrating a process of generating a call sequence based on input text.

Referring to FIG. 4, the generation device 100 may generate a call sequence 400 based on an input text 300. As described above with reference to FIG. 3, the first generation unit 110 of the generation device 100 may generate the call sequence 400 based on the input text 300.

In an embodiment, the generation device 100 may generate the call sequence 400 including at least one call based on the input text 300 of a vehicle passenger by using a pre-trained first language model.

For example, the generation device 100 may configure input data for the first language model, based on input text 300. Thereafter, the generation device 100 may input input data into the first language model and obtain output of the first language model. Thereafter, the generation device 100 may generate the call sequence 400 based on the output of the first language model.

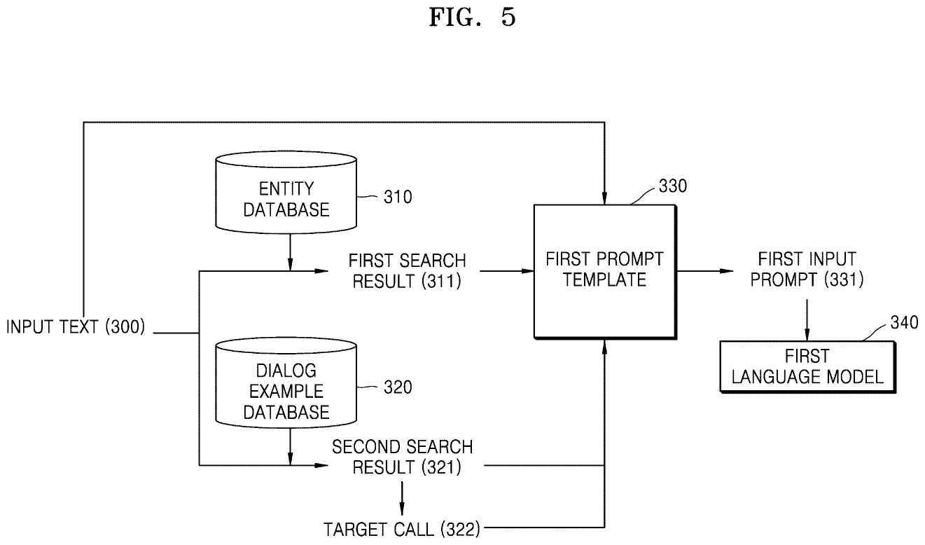

A specific process of configuring input data for the first language model and a specific process of generating the call sequence 400 based on the output of the first language model will be described later with reference to FIGS. 5 to 7, etc.

FIG. 4 shows examples of input text and examples of output of the first language model corresponding to the input text. As an example, in response to obtaining a first input text 301, the generation device 100 may input first input data for a first language model constructed based on the first input text 301 and obtain a first output 302 as output of the first language model.

As another example, in response to obtaining a second input text 303, the generation device 100 may input second input data for a first language model constructed based on the second input text 303, and obtain a second output 304 as output of the first language model.

In an embodiment, a call sequence may include a plurality of calls having a nested structure. Here, a nested structure refers to a structure in which one call includes another call.

For example, if the first input text 301 indicates ‘Find a fast charging station near Seoul Station’, the first output 302, which is output of the first language model corresponding to the first input text 301, may indicate a nested structure in which a call for a charging station search includes a call for searching for a location. The call for a charging station search may have a charging speed condition and a proximity location condition as parameters of the search condition, and the call for searching for a location may be understood as a call that is executed prior to the call for a charging station search in order to set a proximity location condition.

The generation device 100 may generate the call sequence 400 reflecting the nested structure shown in the first output 302, by using the first output 302 of the first language model representing the nested structure.

FIG. 5 is a diagram illustrating a process of generating a first input prompt as an input to the first language model, based on input text.

Referring to FIG. 5, the generation device 100 may preprocess the input text 300 based on at least one of entity search, dialogue example search, and prompt template application. That is, the generation device 100 may configure input data for a first language model 340 by performing preprocessing on the input text 300.

In an embodiment, the generation device 100 may generate a first search result 311 including an entity corresponding to at least one string constituting the input text 300 by using a previously generated entity database 310.

In an embodiment, the entity database 310 may represent a database that includes real-world names and attributes that a user may mention as entity information. The entity database 310 may be configured to include, but is not limited to, the name of the region or the name of the location.

For example, if the input text 300 includes ‘Seoul City’, the generation device 100 may identify ‘a city in Korea’ as an entity corresponding to the string ‘Seoul City’ by searching for the input text 300 against the entity database 310, and generate the first search result 311 based on the identified result.

In an embodiment, the first search result 311 may include a search result of the generation device 100 for the entity database 310. By using a search on the entity database 310, the intent and context of the input text 300 may be accurately identified, thereby increasing the likelihood that a call sequence and response will match the user's intent.

In an embodiment, the generation device 100 may use a previously generated dialogue example database 320 to generate a second search result 321 including at least one dialogue example having, with respect to the input text 300, a similarity higher than or equal to a threshold.

In another embodiment, the generation device 100 may use the dialogue example database 320 to generate the second search result 321 including a preset number of dialogue examples selected based on similarity with the input text 300.

In an embodiment, the dialogue example database 320 may represent a database including dialogue examples that are examples of dialogues that may occur between a user and an agent. An example dialogue according to an embodiment may include input text and an example call sequence corresponding to the input text. Additionally, a dialogue example may further include examples of responses generated based on a call sequence and additional input text.

In an embodiment, the generation device 100 may search for at least one dialogue example having, with respect to the input text 300, a similarity higher than or equal to a threshold, by performing a vector similarity search on the dialogue example database 320. In another embodiment, the generation device 100 may search for a preset number of dialogue examples selected based on similarity thereof to the input text 300 by performing a vector similarity search on the dialogue example database 320.

In an embodiment, each dialogue example may be converted into the form of an embedding vector through sentence embedding and stored in the dialogue example database 320. That is, the dialogue example database 320 may store each dialogue example by mapping the same to an embedding vector corresponding to each dialogue example. Sentence embedding refers to expressing the meaning of a sentence as a numerical embedding vector.

Next, the generation device 100 may generate an embedding vector corresponding to the input text 300 through sentence embedding. The generation device 100 may search for at least one dialogue example from the dialogue example database 320 by searching for an embedding vector that has a similarity higher than or equal to a threshold, with respect to the embedding vector corresponding to the input text 300, or by searching for a preset number of dialogue examples based on those that have a relatively high similarity to the embedding vector corresponding to the input text 300. The generation device 100 may generate the second search result 321 including a found dialogue example.

A similarity between embedding vectors may be calculated as cosine similarity, and the similarity higher than or equal to a threshold may be determined based on any one value in a range of about 0.7 to about 0.9. Additionally, similarity may be calculated using Euclidean distance, but is not limited thereto.

In an embodiment, the second search result 321 may include a search result of the generation device 100 for the dialogue example database 320. By utilizing the dialogue example database 320, the generation device 100 may search for a dialogue example related to the context of the input text 300 and use a found dialogue example to generate a call sequence and/or response appropriate to the dialogue context.

In an embodiment, the generation device 100 may determine at least one call used in at least one dialogue example included in the second search result 321, as a target call 322. For example, the generation device 100 may determine all calls used in all dialogue examples included in the second search result 321 as the target call 322.

As another example, the generation device 100 may determine at least one call selected based on frequency of use among all calls used in all dialogue examples included in the second search result 321, as the target call 322. For example, if the second search result 321 includes a plurality of dialogue examples, the remaining calls, excluding calls used only in one dialogue example, may be determined as the target call 322.

In an embodiment, the generation device 100 may generate a first input prompt 331 for the first language model 340 by applying a previously generated first prompt template 330 to the input text 300, the first search result 311, and the target call 322.

The first prompt template 330 may be a template for generating input data to be provided to the first language model 340, and may be implemented as a structured document or data structure, which is designed in advance to configure a prompt of the first language model 340. In an embodiment, the first prompt template 330 may be defined in, but is not limited to, JSON, Yet Another Markup Language (YAML), or other structured data format.

In an embodiment, the generation device 100 may generate input data in a format understandable by a language model by combining each element constituting input data of the first language model 340 by using the first prompt template 330. That is, the first input prompt 331 according to an embodiment may represent input data of the first language model 340 generated by the generation device 100.

The first prompt template 330 may include slots for respective elements that constitute the first input prompt 331, such as the input text 300, the first search result 311, and/or the target call 322. The generation device 100 may generate the first input prompt 331 by inserting each element into the respective slot thereof of the first prompt template 330.

The first prompt template 330 may further include an instruction to generate a necessary call to satisfy the user's purpose predicted from the input text 300. Additionally, the first input prompt 331 may further include a description of each target call 322.

Unlike FIG. 5, the generation device 100 may generate the first input prompt 331 for the first language model 340 without performing preprocessing including entity search, dialogue example search, or prompt template application. For example, the generation device 100 may generate the first input prompt 331 including the input text 300 and an instruction indicating ‘generate a call necessary to generate a response by using input text’.

As another example, the generation device 100 may generate the first input prompt 331 by performing preprocessing including entity search and dialogue example search, or by performing preprocessing including entity search and prompt template application, or by performing preprocessing including dialogue example search and prompt template application.

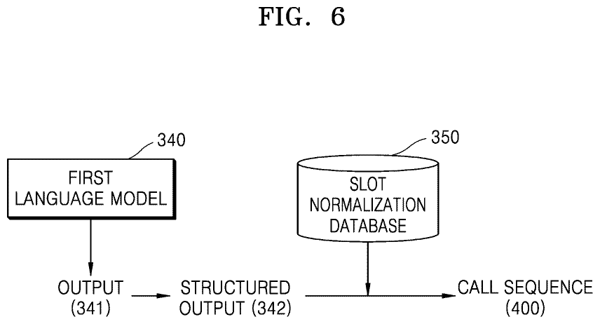

FIG. 6 is a diagram for describing a process of generating a call sequence, based on output of the first language model.

Referring to FIG. 6, the generation device 100 may post-process an output 341 of the first language model 340 based on at least one of parsing and slot normalization. That is, the generation device 100 may generate the call sequence 400 by performing post-processing on the output 341 of the first language model 340.

In an embodiment, the generation device 100 may input the first input prompt 331 to the first language model 340 and obtain the output 341 of the first language model 340. The first output 302 and the second output 304 illustrated in FIG. 4 are examples of the output 341 of the first language model 340.

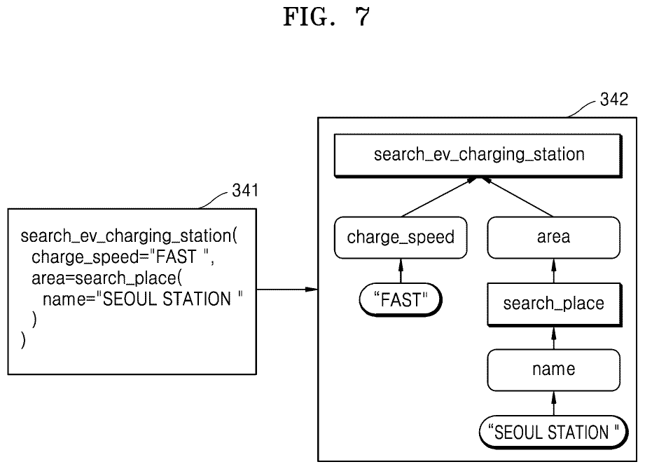

Returning to FIG. 6, the generation device 100 may generate a structured output 342 representing a structure of a string by parsing the output 341 of the first language model 340, which is a string representation. A specific process in which the generation device 100 generates the structured output 342 from the output 341 is described later with reference to FIG. 7.

In an embodiment, the generation device 100 may generate the call sequence 400 by converting at least one string included in the structured output 342 into a normalized expression by using a previously generated slot normalization database 350.

Slot normalization may be understood as processing of synonyms and/or antonyms through unification of string representations. As a user may refer to the same concept in various ways, the output 341 and/or the structured output 342 of the first language model 340 may include various terms that the user has mentioned in the input text 300.

The slot normalization database 350 is a database used to convert various expressions into a unified format according to certain rules. For example, expressions representing ‘gas station’, ‘gas pump’, and ‘refueling place’ may all be normalized to a single form called ‘gas_station’. The slot normalization database 350 may store various expressions that may be understood as being identical to ‘gas_station’ by mapping the expressions to a ‘gas_station’ entry.

The generation device 100 may perform slot normalization on the output 341 or the structured output 342 by changing the expression to ‘gas_station’ if any of the expression is found in the output 341 or the structured output 342.

That is, the generation device 100 may replace at least one string, which is a non-normalized expression, with a normalized expression, by referring to the slot normalization database 350. Accordingly, by configuring the call sequence 400 in a normalized expression, the generation device 100 may reduce ambiguity that may arise from various expression methods and improve the accuracy of data processing, and improve the consistency and clarity of the response generated based on the call sequence 400.

Unlike FIG. 6, the generation device 100 may generate the output 341 as the call sequence 400 without performing separate post-processing, or may generate the call sequence 400 by performing only post-processing based on either parsing or slot normalization on the output 341.

FIG. 7 is a diagram for describing a process of structuring output of the first language model.

Referring to FIG. 7, the generation device 100 may generate the structured output 342 representing a structure of a string by parsing the output 341 of the first language model 340, which is a string representation.

In an embodiment, the output 341 of the first language model 340 may include a string expressed in a text format to indicate at least one call to be executed. For example, the output 341 of the first language model 340 corresponding to an input text indicating ‘Find a fast charging station near Seoul Station’ may be a string expressed as ‘search_ev_charging_station (charge_speed=‘fast’, area=search_place(name=‘Seoul Station’))’.

In an embodiment, the generation device 100 may generate the structured output 342 representing the structure of the string by parsing the output 341. Representing the structure of a string indicates defining a relationship between each component that appears in the string, such as a call or parameter.

In an embodiment, the generation device 100 may identify the structure of the output 341 by analyzing string data constituting the output 341 by performing parsing on the output 341 and separate each component included in the output 341 according to the identified structure.

For example, the output 341 may be expressed as ‘search_ev_charging_station(charge_speed=‘fast’, area=search_place(name=‘Seoul Station’))’. The generation device 100 may define, through parsing, ‘search_ev_charging_station’ as a first call function representing searching for an electric vehicle charging station.

Additionally, the generation device 100 may define ‘charge_speed’ and ‘area’ as a first parameter and a second parameter of the first call function, respectively. Additionally, the generation device 100 may define ‘search_place’ as a second call function used as an argument of the second parameter. Additionally, the generation device 100 may define ‘name’ as a parameter of the second call function. The second call function may be understood as being nested in the first call function through the second parameter.

Additionally, the generation device 100 may define ‘fast’ as an argument value of the first parameter of the first call function and ‘Seoul Station’ as an argument value of the parameter of the second call function.

That is, in an embodiment, the generation device 100 may identify the structure of the output 341 expressed as a string, as in the example described above, and may generate the structured output 342 by defining each component of the output 341 according to the identified structure. The structured output 342 may be expressed in a data format such as JSON or XML, and may be expressed in a tree structure having each component of the output 341, such as a call and a parameter, as a node, but is not limited thereto.

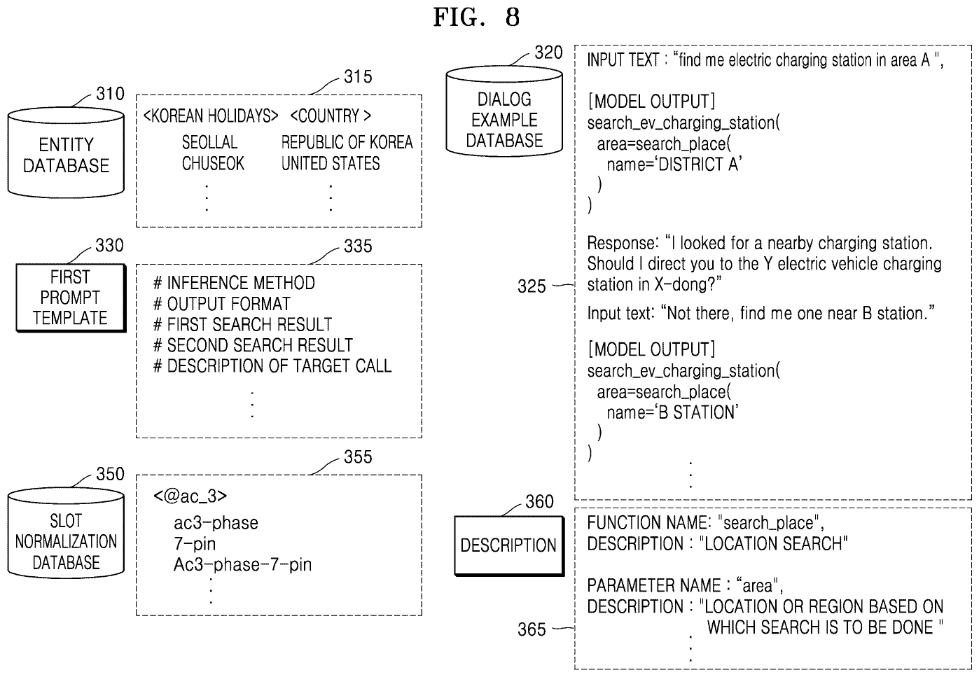

FIG. 8 is a diagram for describing various data used in generating a call sequence.

Referring to FIG. 8, in the process of generating the call sequence 400 based on the input text 300, at least one of the entity database 310, the dialogue example database 320, the first prompt template 330, the slot normalization database 350, and a description 360 may be used.

FIG. 8 illustrates entity information 315 constituting the entity database 310, the dialogue example 325 constituting the dialogue example database 320, an implementation example 335 of the first prompt template 330, normalization information 355 constituting the slot normalization database 350, and an implementation example 365 of the description 360.

In an embodiment, the entity database 310 may include pre-collected entity information 315. The entity information 315 may include a specific entry and various strings that the entry may represent. For example, the entity information 315 may include an entry called ‘Korean holidays’, and may include strings such as ‘Seollal’ and ‘Chuseok’ that the entry ‘Korean holidays’ may represent.

When the input text 300 includes ‘Seollal’ or ‘Chuseok’, the generation device 100 may generate the first search result 311 that includes ‘Korean holidays’ as an attribute mapped to the corresponding string by referring to the entity database 310.

Additionally, in an embodiment, the dialogue example database 320 may include the dialogue example 325 for various dialogue situations collected in advance. For example, the dialogue example 325 may include an example of input text and an example of an output of the first language model 340 for that text. The dialogue example 325 may further include an example response generated from the output of the first language model 340.

The generation device 100 may generate the second search result 321 including at least one dialogue example by searching for a dialogue example similar to the input text 300, in the dialogue example database 320 through a similarity-based search.

Additionally, in an embodiment, the first prompt template 330 may be used to configure input data of the first language model 340.

For example, the first prompt template 330 may include an instruction indicating ‘generate a call necessary to generate a response by using input text’ and a slot for the input text 300. The generation device 100 may generate the first input prompt 331 by inserting the input text 300 into the slot of the input text 300.

As another example, the first prompt template 330 may further include at least one of an inference method and an output format. The inference method may define an algorithm or rule to be applied by the first language model 340 to generate the output 341, and the output format may specify the expression format of the output 341.

As another example, the first prompt template 330 may further include a slot for at least one of various reference data, such as the first search result 311, the second search result 321, the target call 322, and a description of the target call 322. The generation device 100 may generate the first input prompt 331 by inserting reference data into a respective one of slots.

Additionally, in an embodiment, the slot normalization database 350 may include the normalization information 355 that is collected in advance. The normalization information 355 may include a normalized expression and various strings that the expression may represent. For example, the normalization information 355 may include an entry called ‘@ac_3’ as a normalized expression for AC power having three phases, and may include strings that the ‘@ac_3’ entry may represent, such as ‘ac 3-phase’, ‘7 pins’, and ‘ac 3-phase 7-pins’.

When the output 341 or the structured output 342 includes ‘ac3 phase’, ‘7-pin’, or ‘ac 3-phase 7-pin’, the generation device 100 may generate the call sequence 400 by changing the corresponding string to ‘@ac_3’ by referring to the slot normalization database 350.

Additionally, in an embodiment, the description 360 may include comprehensive information about a call, such as the definition, purpose, function, calling method, types of available parameters, format and/or content of returned response data for each of the plurality of calls.

For example, the description 360 may include information describing the names of the call functions and the purpose and function of each call function. Additionally, the description 360 may include names of parameters that may be used as arguments of the call function and descriptions of the functions and usage methods of each parameter.

In an embodiment, the generation device 100 may insert descriptions for all calls that may be generated from the first language model 340 into the first input prompt 331 to construct the call sequence 400. The first language model 340 may generate the output 341 including at least one call that matches the purpose of the input text 300 by referring to the description of all calls together with the input text 300.

In another embodiment, the generation device 100 may insert, into the first input prompt 331, the description of the target call 322 selected from the second search result 321 as a reference result of the dialogue example database 320. The first language model 340 may generate the output 341 including at least one call that matches the purpose of the input text 300 by referring to a description of the selected target call 322 together with the input text 300.

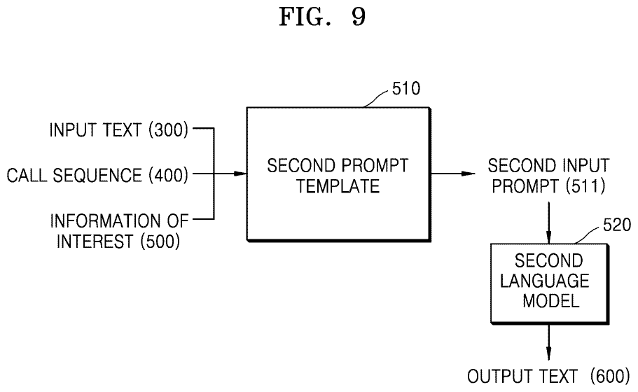

FIG. 9 is a diagram for describing a process of generating output text by using a second language model.

Referring to FIG. 9, the generation device 100 may generate an output text 600 corresponding to the input text 300 based on information of interest 500 using a second language model 520 that is pre-trained. The information of interest 500 may be identical to the information of interest obtained by the generation device 100 through the process of obtaining the information of interest described above with reference to FIG. 3, etc.

For example, the generation device 100 may obtain the information of interest 500 by executing at least one call constituting the call sequence 400. As an example, in the first call and the second call constituting the call sequence 400, the generation device 100 may obtain first external information from the first external device by executing the first call, and may obtain second external information from the second external device by executing the second call. The information of interest may include the first external information and the second external information.

As described above with reference to FIG. 3, the call sequence 400 used to obtain the information of interest 500 may include all calls for generating the output text 600. Accordingly, the generation device 100 may generate the call sequence 400 including all calls necessary for generating the output text 600 by using a single input/output process of the first language model 340, instead of repeating the input/output process of the first language model 340 multiple times.

Thereafter, the generation device 100 may obtain all the information of interest 500 necessary for generating the output text 600 by executing all calls included in the call sequence 400, and generate the output text 600 based on the obtained information of interest 500.

In an embodiment, the generation device 100 may generate output text based on the input text 300 and the information of interest 500. For example, the generation device 100 may configure input data for the second language model 520 based on the input text 300 and the information of interest 500, and input the input data into the second language model 520 to generate the output text 600 as output of the second language model 520.

In an embodiment, the generation device 100 may generate a second input prompt 511 based on the input text 300 and the information of interest 500. Additionally, in an embodiment, the generation device 100 may generate the second input prompt 511 based on the input text 300, the call sequence 400, and the information of interest 500. The second input prompt 511 may be understood as the input data for the second language model 520.

In an embodiment, the generation device 100 may generate the second input prompt 511 for the second language model 520 by applying a second prompt template 510, which is previously generated, to at least one of the input text 300, the call sequence 400, and the information of interest 500.

The second prompt template 510 is a template for generating the second input prompt 511 to be provided to the second language model 520, and may be implemented as a structured document or data structure designed in advance to configure input data of the second language model 520. In an embodiment, the second prompt template 510 may be defined in, but is not limited to, JSON, YAML, or other structured data format.

In an embodiment, the generation device 100 may generate input data in a format understandable by a language model by combining each element constituting the second input prompt 511 by using the second prompt template 510.

The second prompt template 510 may include slots each for a respective element that constitutes the second input prompt 511, such as the input text 300, the call sequence 400, and the information of interest 500. The generation device 100 may generate the second input prompt 511 by inserting each element into a respective slot of the second prompt template 510. The second prompt template 510 may further include an instruction to generate an answer to the input text 300 by using the information of interest 500.

In an embodiment, the second prompt template 510 may include an instruction indicating ‘generate a natural language answer corresponding to input text by using information of interest’, a slot for the input text 300, and a slot for the information of interest 500. The generation device 100 may generate the second input prompt 511 by inserting the input text 300 and the information of interest 500 into each slot.

As another example, the second prompt template 510 may further include at least one of an inference method and an output format. The inference method may define an algorithm or rule to be applied by the second language model 520 to generate the output text 600, and the output format may specify the expression format of the output text 600. For example, the output format may include, but is not limited to, whether honorifics are used and a maximum character limit.

As another example, the second prompt template 510 may further include a slot for at least one of various reference data, such as the call sequence 400. The generation device 100 may generate the second input prompt 511 by inserting reference data such as the call sequence 400 into each slot.

As the generation device 100 generates the second input prompt 511 reflecting the call sequence 400, the second language model 520 may reflect a process of obtaining the information of interest 500 from the input text 300 to the call sequence 400 and the information of interest 500, in the process of generating the output text 600, and thus the correlation between the input text 300 and the output text 600 may be improved.

In an embodiment, the generation device 100 may update the dialogue history by adding the input text 300 to the dialogue history. Thereafter, the generation device 100 may generate the call sequence 400 based on the input text 300, obtain the information of interest 500 based on the call sequence 400, and generate the output text 600 based on the updated dialogue history and the information of interest 500. The dialogue history may represent the dialogue history described above with reference to FIG. 3.

In an embodiment, the generation device 100 may generate the second input prompt 511 based on the dialogue history and the information of interest 500 with the input text 300 that is added.

As an example, the generation device 100 may generate the second input prompt 511 for the second language model 520 by applying the second prompt template 510 that is previously generated, to the updated dialogue history and the information of interest 500. The second prompt template 510 according to an embodiment may include one slot each for the dialogue history and the information of interest 500 including the input text 300. The generation device 100 may generate the second input prompt 511 by inserting each element into a respective slot thereof of the second prompt template 510.

By generating the second input prompt 511 for the second language model 520 based on the dialogue history and the information of interest 500, the second language model 520 may generate the output text 600 by reflecting the previous dialogue context and dialogue pattern shown in the dialogue history.

In an embodiment, the generation device 100 may provide the generated output text 600 to a user via a display device. For example, the generation device 100 may provide the output text 600 through the display device by transmitting the generated output text 600 to the display device, or by generating an interface (e.g., graphic user interface (GUI)) including output text and transmitting the same to the display device.

As an example, a vehicle system may include the generation device 100 and a display device. The generation device 100 may generate the output text 600 based on the input text 300 of a user riding in a vehicle, generate a vehicle interface including the output text 600, and transmits the same to the display device, thereby providing the output text 600 to the user riding in the vehicle.

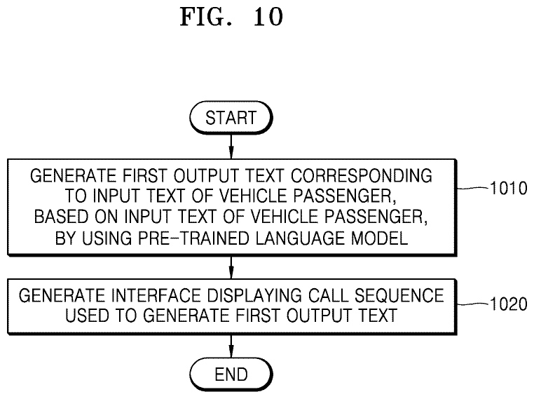

FIG. 10 is an example of an operating method of a generation device operating to visualize a call sequence of an interactive agent.

Referring to FIG. 10, in operation 1010, the generation device 100 may generate a first output text corresponding to an input text of a vehicle passenger, based on the input text of the vehicle passenger, by using a pre-trained language model.

In operation 1020, the generation device 100 may generate an interface displaying a call sequence used to generate the first output text. The interface may display each of a plurality of unit executions included in the call sequence.

In an embodiment, each of the plurality of unit executions may represent one call or one parameter.

An interface according to an embodiment may display a visual element corresponding to each of a plurality of unit executions, and the visual element according to an embodiment may include at least one of an icon and text.

An interface according to an embodiment may display a call sequence in a tree structure by using a plurality of visual elements, and each unit execution according to an embodiment may be a node of the tree structure.

In an embodiment, the generation device 100 may generate an interface that displays a parent node during a plurality of unit executions, and may change, based on receiving of an expansion input for the parent node, the interface to display more child nodes for the parent node.

In an embodiment, each of the plurality of visual elements may be determined based on at least one of a node-specific description and a node-specific argument value.

In an embodiment, a certain unit execution included in the plurality of unit executions may represent a preset type of information access. The generation device 100 may generate an interface that further displays a visual effect corresponding to a preset type of information access on a visual element representing a predetermined unit execution.

In an embodiment, the generation device 100 may generate an interface that displays a predetermined unit execution included in a call sequence, and may change the interface to display detailed information of the predetermined unit execution, based on receiving of a detailed information providing input for a predetermined node.

The detailed information may include at least one of information regarding a description of a predetermined unit execution, information regarding an argument value of a predetermined unit execution, and information regarding an execution result of a predetermined unit execution.

In an embodiment, the generation device 100 may update the call sequence based on user input. The generation device 100 may generate a second output text corresponding to the input text, based on the updated call sequence, and change the interface to display the second output text and the updated call sequence.

In an embodiment, the generation device 100 may generate an interface that displays a first visual element representing a predetermined unit execution included in a call sequence. The generation device 100 may update the call sequence by changing the argument value of the predetermined unit execution in the call sequence, based on receiving a change input for the predetermined unit execution. Thereafter, the generation device 100 may change the interface to display a second visual element indicating a predetermined unit execution in which the argument value has changed. The second visual element may be different from the first visual element.

Additionally, in an embodiment, the generation device 100 may provide at least one change suggestion for the predetermined unit execution, based on receiving of a first change input for the predetermined unit execution. The generation device 100 may update the call sequence by changing the argument value of the predetermined unit execution, based on receiving of a second change input for selecting one of at least one change suggestion.

Additionally, in an embodiment, the generation device 100 may generate an interface that represents a predetermined unit execution included in a call sequence. The generation device 100 may update the call sequence by deleting a predetermined unit execution from the call sequence, based on receiving of a delete input for the predetermined unit execution.

Additionally, in an embodiment, the generation device 100 may update a call sequence by adding a predetermined unit execution to the call sequence, based on receiving of an addition input for the predetermined unit execution.

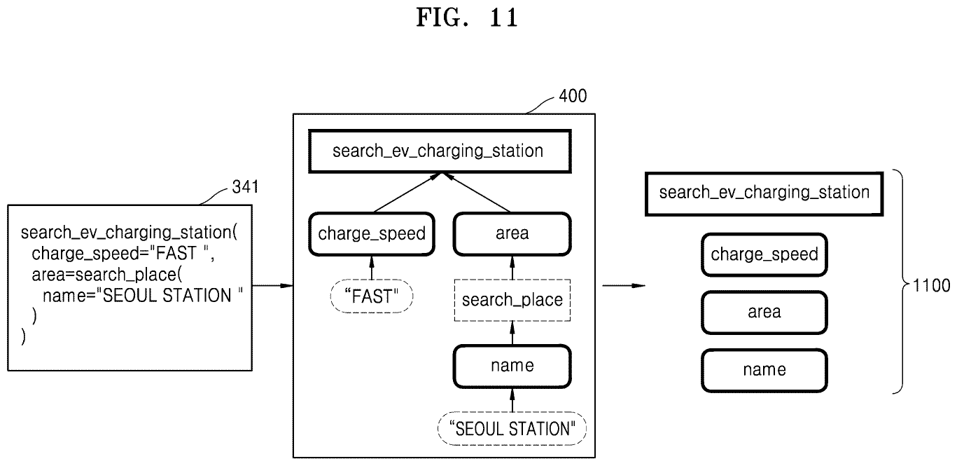

FIG. 11 is a diagram for describing a unit execution included in a call sequence.

In an embodiment, the generation device 100 may generate a first output text corresponding to the input text 300 based on the input text 300 of a user by using a pre-trained language model. In an embodiment, the user may include a vehicle passenger.

A process in which the generation device 100 generates the first output text may be the same as the process in which the generation device 100 generates the output text 600 based on the input text 300 described above with reference to FIGS. 3 to 9. Additionally, a language model used to generate the first output text may include at least one of the first language model 340 and the second language model 520.

For example, the generation device 100 may generate the call sequence 400 based on the input text 300, obtain the information of interest 500 based on the call sequence 400, and generate the first output text based on the information of interest 500.

In an embodiment, the generation device 100 may generate an interface that displays the call sequence 400 used to generate the first output text. The interface may display each of a plurality of unit executions 1100 included in the call sequence 400. In an embodiment, each of the plurality of unit executions 1100 may represent one call or one parameter. The call sequence 400 may be identical to the call sequence 400 described above with reference to FIGS. 3 to 9, etc.

Each of the plurality of unit executions 1100 may represent one call or one parameter. In an embodiment, a call as a unit execution may include obtaining various data from a memory of the generation device 100 or the external device 200, or requesting a specific task from the memory or the external device 200, in order for the generation device 100 to generate a response corresponding to the input text 300. In an embodiment, a call may represent a call function corresponding to a single function.

As an example, the call may include calling an API endpoint of the external device 200 to obtain data from the external device 200. As another example, the call may include a system command call to control at least a portion of a hardware or software component of a certain system (e.g., vehicle system) that includes the generation device 100. As another example, the call may include, but is not limited to, a database query call that executes a query to retrieve or modify information from a database accessible by the generation device 100.

In an embodiment, as a unit execution, parameters may include variables or constants used as input values of a call implemented as a call function, etc.

As an example, the parameters may include parameters for passing conditions for filtering specific data when calling an API endpoint of the external device 200. As another example, the parameters may include parameters for adjusting the operation of a particular algorithm running on a predetermined system that includes the generation device 100. As another example, the parameters may include parameters for specifying search conditions when calling a database query.

In an embodiment, the generation device 100 may classify the call sequence 400 into calls, parameters, and argument values of the parameters, and select the plurality of unit executions 1100 to be displayed, among the calls and parameters based on the classification results.

For example, the generation device 100 may select all calls and all parameters as the plurality of unit executions 1100, or may select the plurality of unit executions 1100 according to preset criteria. The preset criteria may be appropriately set within the range to achieve the purpose of intuitive visualization, such as importance of each call, importance of each parameter, and the maximum number of selections.

In an embodiment, the generation device 100 may visualize the generation process of the first output text by generating an interface that displays the plurality of unit executions 1100 included in the call sequence 400 used to generate the first output text. That is, the generation device 100 may visualize the call sequence 400 used in the process in which an interactive agent generates a response to the user's input.

Referring to FIG. 11, the generation device 100 may generate the output 341 by using the first language model 340 that is pre-trained, and generate the call sequence 400 based on the output 341 of the first language model 340.

In FIG. 11, the call sequence 400 is illustrated in a tree structure for convenience of description, but the call sequence 400 may be implemented in a certain text format such as JSON or XML. Additionally, the call sequence 400 according to an embodiment may be identical to the output 341 or may be generated by performing post-processing such as structuring and/or slot normalization on the output 341.

The generation device 100 may select, as the plurality of unit executions 1100 to be visualized, from among a plurality of calls and parameters included in the call sequence 400, a first call expressed as ‘search_ev_charging_station’ and indicating a search for an electric vehicle charging station, a first parameter expressed as ‘charge_speed’ and indicating a condition regarding a charging speed, a second parameter expressed as ‘area’ and indicating a search reference location condition, and a third parameter expressed as ‘name’ and indicating a location search term condition for the second parameter.

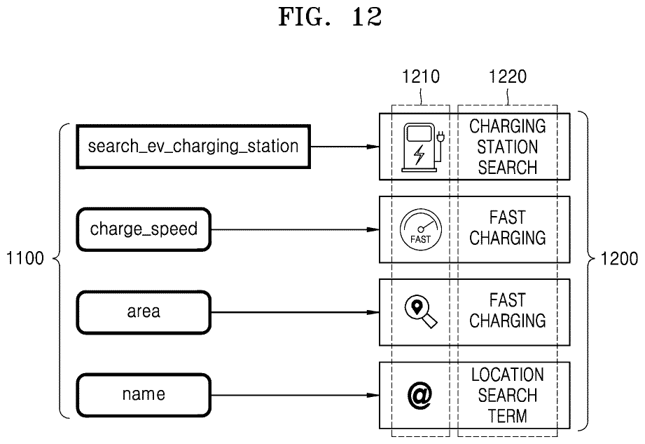

FIG. 12 is a diagram for describing visual elements corresponding to unit executions.

Referring to FIG. 12, the generation device 100 may generate an interface that displays visual elements 1200 respectively corresponding to the plurality of unit executions 1100. That is, the interface according to an embodiment may display the visual elements 1200 respectively corresponding to the plurality of unit executions 1100, and the visual elements 1200 according to an embodiment may include at least one of an icon 1210 and a text 1220.

In an embodiment, the call sequence 400 may represent a hierarchical structure including parallel structures and/or nested structures. The generation device 100 may interpret the call sequence 400 as a tree structure including a plurality of nodes by analyzing the structure of the call sequence 400. The plurality of nodes forming the tree structure may each correspond to a respective unit execution.

For example, when the first call described above with reference to FIG. 11 is referred to as a root node, the first parameter and the second parameter may be understood as child nodes of the first call having a parallel structure with each other, and the third parameter may be understood as a child node of the second parameter.

In an embodiment, the generation device 100 may generate an interface representing a tree structure having each of the plurality of unit executions 1100 as a node. That is, an interface according to an embodiment may display the call sequence 400 in a tree structure by using the plurality of visual elements 1200, and each unit execution according to an embodiment may be a node of the tree structure.

In an embodiment, each of the plurality of visual elements 1200 may be determined based on at least one of a node-specific description and a node-specific argument value. For example, an icon 1210 corresponding to a node may be determined based on at least one of a description of the node and an argument value of the node. Additionally, for example, the text 1220 corresponding to a node may be determined based on at least one of a description of the node and an argument value of the node.

Below, with reference to FIG. 12, an example is provided, which illustrates an example of a visualization process of the call sequence 400 having the first call, the first parameter, the second parameter, and the third parameter as nodes.

The call sequence 400 is generated in the process of generating a response from an interactive agent, based on the input text 300 indicating ‘Find a fast charging station around Seoul Station’. Additionally, the first call, the first parameter, the second parameter, and the third parameter correspond to first to fourth nodes.

A description corresponding to the first node may include ‘Search for electric vehicle charging stations’, and an argument value of the first node may include the second to fourth nodes. The icon 1210 corresponding to the first node may be implemented as an icon that intuitively represents a search for an electric vehicle charging station.

Additionally, the text 1220 corresponding to the first node may be implemented as ‘charging station search’, etc., which intuitively indicates the function of searching for an electric vehicle charging station.

By generating an interface that displays the visual element 1200 corresponding to the first node, the generation device 100 may intuitively display that a search for an electric vehicle charging station has been performed in generating of a response corresponding to the input text 300.

Additionally, a description corresponding to the second node may include ‘charging speed’, and an argument value of the second node may include ‘fast’ or ‘standard’, etc. The icon 1210 corresponding to the second node may be implemented as an icon that intuitively indicates fast charging by further reflecting the argument value in the description of the second node. Additionally, the text 1220 corresponding to the second node may be implemented as ‘fast charging’, etc., which intuitively indicates fast charging as a condition for a charging station search.

By generating an interface that displays the visual element 1200 corresponding to the second node, the generation device 100 may intuitively display that a charging speed condition has been taken into account in generating of a response corresponding to the input text 300 and also that the condition has been set to fast charging.

Additionally, a description corresponding to the third node may include a ‘search reference location’, and the argument value of the third node may include the fourth node. The icon 1210 corresponding to the third node may be implemented as an icon that intuitively indicates that the surrounding area of a specific location has been set as a search target. Additionally, the text 1220 corresponding to the third node may be implemented as ‘location search’, etc., which intuitively indicates a location condition for a charging station search.

By generating an interface that displays the visual element 1200 corresponding to the third node, the generation device 100 may intuitively display that the location condition of the charging station search has been taken into consideration, in generating of a response corresponding to the input text 300.

Additionally, a description corresponding to the fourth node may include a ‘location search term’, and the argument value of the fourth node may include a place name such as ‘Seoul Station’. The icon 1210 corresponding to the fourth node may be implemented as an icon that intuitively represents a search term condition. Additionally, the text 1220 corresponding to the fourth node may be implemented as a ‘location search term’ or the like indicating a search term for setting a location condition for a charging station search.

By generating an interface that displays the visual element 1200 corresponding to the fourth node, the generation device 100 may intuitively display that a search location condition in which a predetermined location search term is applied is reflected in generating of a response corresponding to the input text 300.

In another embodiment, for the input text 300 indicating ‘Considering my schedule, recommend food to eat while charging the vehicle battery at the next rest stop I encounter’, the generation device 100 may generate the call sequence 400 that includes searching the user's schedule, searching for a point of interest on the navigation route, checking the remaining vehicle battery level, and searching for a restaurant.

The generation device 100 may obtain the information of interest 500 by executing the call sequence 400 and generate the first output text indicating ‘Shall I order and reserve a simple French fries so that I don't miss the schedule? The parking area where charging is possible is area A.’

The generation device 100 may determine each unit execution 1100 that constitutes the call sequence 400 used for generation of the first output text, i.e., searching for a user's schedule, searching for a point of interest on a navigation route, a charging station search within the point of interest, and searching for a restaurant within the point of interest, as the target of visualization.

The generation device 100 may intuitively display that it has considered the user's schedule, confirmed that the rest stop to be visited is a place of interest on the route, confirmed whether charging is possible at the rest stop, and confirmed that available restaurants at the rest stop are open by generating an interface that displays the visual elements 1200 corresponding to a respective one of the plurality of unit executions 1100.

According to an embodiment, the generation device 100 may convey to the user the specific process of generating a response, such as what information was used in the response of the interactive agent and what conditions were set, through visualization of the plurality of unit executions 1100.

As the generation device 100 generates an interface that displays the visual element 1200 of each of the plurality of unit executions 1100, a process by which the response of the interactive agent was generated may be intuitively viewed, thereby improving the user's interpretability of the operation of the interactive agent.

Accordingly, hindering the interpretability of responses and blocking attempts at error improvement due to interactive agents according to the related art functioning as black boxes, operation processes of which cannot be interpreted, may be addressed.

In an embodiment, the generation device 100 may generate an interface that displays all of the visual elements 1200 respectively corresponding to the plurality of unit executions 1100. For example, the generation device 100 may display an interface that displays the visual elements 1200 respectively corresponding to the plurality of unit executions 1100 in a predetermined direction around a display location of the first output text. Thus, the user may intuitively check each unit execution used to generate the first output text.

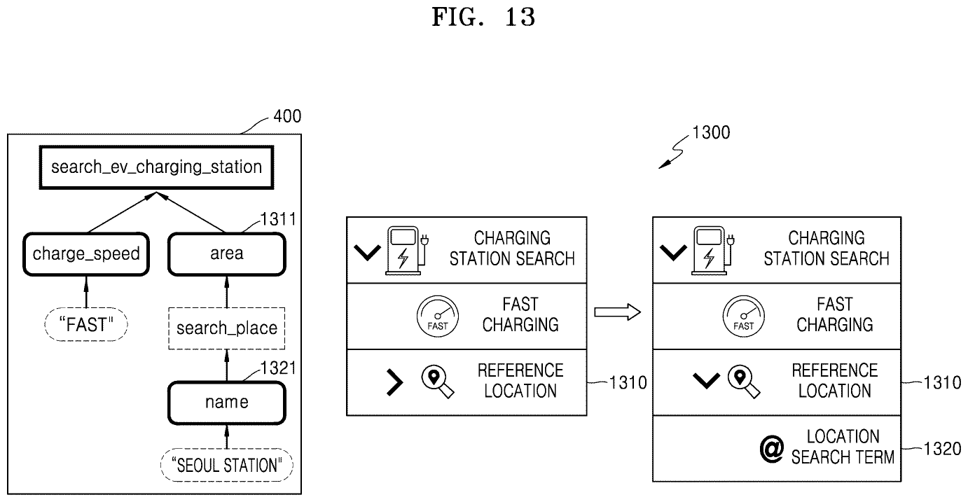

FIG. 13 is a diagram illustrating an interface that displays a hierarchical structure of a call sequence.

Referring to FIG. 13, the call sequence 400 may represent a hierarchical structure. For example, the call sequence 400 may represent a tree structure. In an embodiment, the generation device 100 may visualize the hierarchical structure of the call sequence 400 by generating an interface that displays structured visual elements 1300.

In an embodiment, the plurality of unit executions 1100 constituting the call sequence 400 may include a unit execution corresponding to at least one parent node 1311 and a unit execution corresponding to a child node 1321 of the parent node. The generation device 100 may generate an interface that displays the parent node 1311 among the plurality of unit executions 1100, and based on receiving of an expansion input for the parent node 1311, the generation device 100 may change the interface to further display the child node 1321 of the parent node 1311.

For example, the generation device 100 may generate an interface that displays the visual element 1300 that is structured and includes a first visual element 1310 corresponding to the parent node 1311 among the plurality of unit executions 1100 and does not include a second visual element 1320 corresponding to the child node 1321.

Thereafter, the generation device 100 may receive the expansion input for the parent node 1311. For example, the generation device 100 may receive an expansion input in a preset manner, such as clicking on the first visual element 1310 corresponding to the parent node 1311 or selecting the same through a user gesture such as a touch.

As an example, the visual element 1300 that is structured may display a folding icon in parallel with the first visual element 1310 corresponding to the parent node 1311. The generation device 100 may receive an expansion input from a user selecting a folding icon. The generation device 100 may change the selected folding icon into an open icon based on the received user's expansion input.

Thereafter, the generation device 100 may generate an interface that displays the visual element 1300 that is structured and includes the second visual element 1320 corresponding to the child node 1321 together with the first visual element 1310 in response to receiving the expansion input.

As an example, a parameter expressed as ‘name’ may be included as an argument value of a parameter expressed as ‘area’. The parameter expressed as ‘area’ may be a unit execution corresponding to the parent node 1311 of the parameter expressed as ‘name’, and the parameter expressed as ‘name’ may be a unit execution corresponding to the child node 1321 of the parameter expressed as ‘area’. The parameter expressed as ‘area’ may indicate a search reference location condition, and the parameter expressed as ‘name’ may indicate a location search term.

First, the generation device 100 may generate an interface that displays the visual element 1300 that is structured, includes the first visual element 1310 representing a search reference location, and does not include the second visual element 1320 representing a location search term.

Thereafter, based on receiving of a user's expansion input for the first visual element 1310 corresponding to a search reference location, the generation device 100 may generate an interface that displays the visual element 1300 that is structured and that includes, together with the first visual element 1310, the second visual element 1320 representing a location search term, which is a child node of the search reference location.

Accordingly, the user may first check the hierarchical structure in which the plurality of unit executions 1100 are simplified, and then check an expanded hierarchical structure by expanding a parent node requiring specific confirmation as needed, and then further check child nodes.

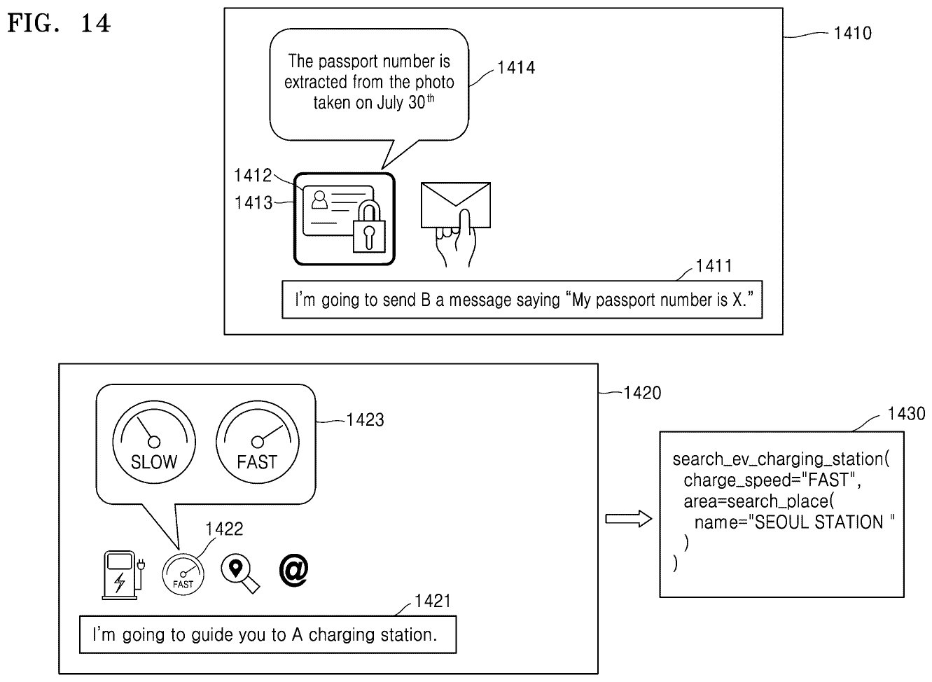

FIG. 14 is a diagram illustrating a process in which an interface displaying a call sequence interacts with a user.

Referring to FIG. 14, as examples of interfaces generated by the generation device 100, a first interface 1410 corresponding to a first output text 1411 and a second interface 1420 corresponding to a second output text 1421 may be identified.

In an embodiment described below, the interface generated by the generation device 100 may represent the first interface 1410.

In an embodiment, a predetermined unit execution included in the plurality of unit executions 1100 may represent a preset type of information access. For example, access to a preset type of information may include a query of personal information based on the information being queried, or a query of a specific database based on the database being queried.

As other examples, access to a predefined type of information may include access to location-based information that may be identified as a specific type of information, such as viewing current or past locations, access to financial information, such as viewing e-commerce transaction history, access to medical information, such as viewing medication records, or access to social media information, such as viewing user-generated posts.

When a certain type of information access is performed, the user may request that the corresponding type of information access has occurred be indicated to the user. In an embodiment, an entity providing an interactive artificial intelligence service or the user himself/herself may preset the type of information access to be displayed to the user.

When the plurality of unit executions 1100 include a predetermined unit execution representing a preset type of information access, the generation device 100 may generate an interface that further displays a visual effect 1413 corresponding to the preset type of information access on a visual element 1412 representing the predetermined unit execution.

The visual effect 1413 may be set differently according to the type of preset information access. The visual effect 1413 according to an embodiment may include displaying an additional object having a particular size, shape, color, and/or animation effect around the visual element 1412.

For example, a first visual effect corresponding to a first type of information access may include displaying edges of a first color around the visual element 1412, and a second visual effect corresponding to a second type of information access may include displaying edges of a second color around the visual element 1412. The first type may correspond to a personal information query, and the second type may correspond to a query for a specific database, but is not limited thereto.

In an embodiment, the generation device 100 may generate an interface that displays a predetermined unit execution included in a call sequence, and based on receiving a detailed information providing input for the predetermined unit execution, may change the interface to display detailed information 1414 of the predetermined unit execution.

The detailed information providing input according to an embodiment may include a user input in a preset manner for a predetermined node corresponding to a predetermined unit execution. A method of inputting the detailed information providing input may be set to a short click or short touch on the visual element 1412, but is not limited thereto.

The detailed information 1414 according to an embodiment may include at least one of information regarding a description of a predetermined unit execution, information regarding an argument value of a predetermined unit execution, and information regarding an execution result of a predetermined unit execution.

Information regarding a description of a predetermined unit execution according to an embodiment may include a description of the purpose and/or function of the unit execution. Additionally, information about an argument value of a predetermined unit execution according to an embodiment may include a description of a parameter or a value of a parameter included in the unit execution. Additionally, information about an execution result of a predetermined unit execution according to an embodiment may include a description of at least some of information obtained as a result of the executed unit execution.

For example, the detailed information 1414 according to an embodiment may include search provider information as a description of a predetermined unit execution or information regarding argument values. The search provider information may include information about search providers that provide search services using a search engine, such as web search providers, specific database search providers, or geographic search providers.

The generation device 100 may inform, through the detailed information 1414, the user of a source of information by indicating which search provider a unit execution representing the search is using.

As an example of providing detailed information, a predetermined unit execution might represent a call to search for a photo of the user's passport from the user's photo album database. A description of a call may include ‘personal photo album search’, an argument value of a unit execution may include a search target condition of a photo (e.g., a photo of an ID card), and an execution result of the unit execution may include information about a found photo (e.g., the date the photo is taken) and the passport number.

In response to receiving a detailed information providing input for selecting the visual element 1412 representing a call to search for a photo of the user's passport from the user's photo album, the generation device 100 may change the interface to display the detailed information 1414 including information indicating that the passport number was extracted from a photo included in the personal photo album and the date the photo used to extract the passport number was taken.

In an embodiment described below, the interface generated by the generation device 100 may represent the second interface 1420.

In an embodiment, the generation device 100 may update the call sequence 400 based on user input. The generation device 100 may generate a second output text corresponding to the input text 300 based on an updated call sequence 1430 and change the interface to display the second output text and the updated call sequence 1430.

The second information of interest used to generate the second output text may be different from the first information of interest used to generate the first output text. Additionally, the second output text may be different from the first output text.

An update may include at least one of adding, deleting, and changing a predetermined unit execution. That is, the generation device 100 may generate the updated call sequence 1430 by changing and/or deleting at least one unit execution constituting the call sequence 400 based on user input or by adding at least one unit execution to the call sequence 400.

A user input method corresponding to adding, deleting, and changing a predetermined unit execution may be preset. For example, the user input method corresponding to any one of adding, deleting, and changing a predetermined unit execution may be appropriately set considering the user experience among various input methods such as tap, long press, double tap, triple tap, swipe, pinch zoom in/out, click, double click, and drag.

As another example, the generation device 100 may generate an interface that displays a menu area indicating ‘add’, ‘delete’, and ‘change’, etc., in response to receiving of user input for selecting a predetermined unit execution (e.g., user input selecting a visual element corresponding to the predetermined unit execution). Thereafter, the generation device 100 may obtain a user input corresponding to one of adding, deleting, and changing a predetermined unit execution by receiving a user input selecting one of ‘add’, ‘delete’ and ‘change’ shown in the menu area.

After the updated call sequence 1430 is generated, the generation device 100 may obtain the information of interest 500 by executing the updated call sequence 1430 and generate the second output text based on the obtained information of interest 500. As the updated call sequence 1430 may be different from the call sequence 400 before the update, the information of interest 500 obtained by executing the call sequence 400 before the update may be different from the information of interest 500 obtained by executing the updated call sequence 1430.

In an embodiment, the call sequence 1430 including a single input/output process of the first language model 340 may be generated. The generation device 100 may generate the updated call sequence 1430 by adding, deleting, and/or changing a predetermined unit execution according to user input, and thus the second output text may be generated based on the updated call sequence 1430 by using only the second language model 520 without using the input/output process of the additional first language model 340.

Accordingly, manipulability is added to the response generation process of the interactive agent, allowing the user to directly manipulate calls used to generate the answer to obtain a desired response, and improving the user experience of interacting with the interactive agent.

In an embodiment, the generation device 100 may generate an interface that displays a first visual element 1422 representing a predetermined unit execution included in the call sequence 400. The generation device 100 may update the call sequence 400 by changing the argument value of the predetermined unit execution in the call sequence 400, based on receiving a change input for the predetermined unit execution.

Then, the generation device 100 may change the interface to display the second visual element indicating the predetermined unit having a changed argument value. The second visual element may be different from the first visual element 1422.

For example, a unit execution corresponding to the first visual element 1422 may include ‘fast charging’ as an argument value as a search condition for a charging station search, and a unit execution corresponding to the second visual element, i.e., a changed unit execution, may include ‘slow charging’ as an argument value. The first visual element 1422 may include an icon indicating fast charging, and the second visual element may include an icon indicating slow charging.

The method of inputting a change input according to an embodiment may be set to a specific gesture such as a long press on the first visual element 1422, or a voice utterance input requesting a change, but is not limited thereto. For example, a change input may be a user's voice utterance indicating ‘Find me a slow charging station, not a fast charging station.’ As another example, the change input may be a user's voice utterance indicating ‘Find me one around Gangnam Station, not Seoul Station.’

Additionally, in an embodiment, the generation device 100 may provide at least one change suggestion 1423 for a predetermined unit execution based on receiving of a first change input for the predetermined unit execution. The generation device 100 may update the call sequence 400 by changing the argument value of the predetermined unit execution, based on receiving of a second change input for selecting at least one of the change suggestions 1423.

The method of inputting the first change input according to an embodiment may be set to a specific gesture such as a long press on a visual element corresponding to the predetermined unit execution, or a voice utterance input requesting a change, but is not limited thereto.

Additionally, the method of inputting the second change input according to an embodiment may be set to, but is not limited to, a click, a touch, and/or a voice utterance input for selecting one of at least one proposed change candidate.

For example, the call sequence 400 may include a predetermined unit execution that includes a first argument value. The generation device 100 may receive from a user a first change input for selecting the first visual element 1422 corresponding to a predetermined unit execution, and in response to receiving of the first change input, generate an interface that displays the first argument value and a second argument value, as the change suggestion 1423 for the predetermined unit execution. As an example, the first argument value may represent ‘fast charging’ for the charging station search condition, and the second argument value may represent ‘slow charging’.

The generation device 100 may receive, from a user, a second change input for selecting the second argument value, and in response to receiving of the second change input, generate the updated call sequence 1430 by changing the first argument value of the call sequence 400 to the second argument value. The generation device 100 may obtain the information of interest 500 by executing the updated call sequence 1430 and generate the second output text based on the information of interest 500, thereby reflecting a change in the unit execution and providing a response that better matches the user's intention.

Thereafter, the generation device 100 may change the interface displaying the first visual element 1422 representing the first argument value to an interface displaying a visual element representing the second argument value.

Additionally, in an embodiment, the generation device 100 may generate an interface that represents a predetermined unit execution included in the call sequence 400. The generation device 100 may update the call sequence by deleting a predetermined unit execution from the call sequence 400 based on receiving of a delete input for a predetermined unit execution.

The method of inputting a delete input according to an embodiment may be set to a gesture such as a double tap on a visual element corresponding to a predetermined unit execution, or as a voice input requesting deletion, but is not limited thereto. For example, a delete input may be a user's spoken utterance indicating ‘fast or slow, it doesn't matter’.

In an embodiment, the generation device 100 may receive a delete input for a predetermined unit execution, and in response to receiving of the delete input, delete the predetermined unit execution from the call sequence 400 to generate the updated call sequence 1430. The generation device 100 may obtain the information of interest 500 by executing the updated call sequence 1430 and generate the second output text based on the information of interest 500, thereby reflecting the deletion of the unit execution and providing a response that better matches the user's intention.

Additionally, in an embodiment, the generation device 100 may update the call sequence by adding a predetermined unit execution to the call sequence, based on receiving of an addition input for the predetermined unit execution.

The method of inputting an addition input according to an embodiment may be set to, but is not limited to, clicking or touching a specific area of the interface on which the call sequence 400 is displayed, such as a display area of the first output text, or a voice utterance input requesting addition of a unit execution. For example, an addition input may be a user's spoken utterance indicating ‘Search for charging stations that serve food’.

In an embodiment, the generation device 100 may receive an addition input for a predetermined unit execution, and in response to receiving of the addition input, may generate the updated call sequence 1430 by adding the predetermined unit execution to the call sequence 400. The generation device 100 may obtain the information of interest 500 by executing the updated call sequence 1430 and generate the second output text based on the information of interest 500, thereby reflecting the addition of the unit execution and providing a response that better matches the user's intention.

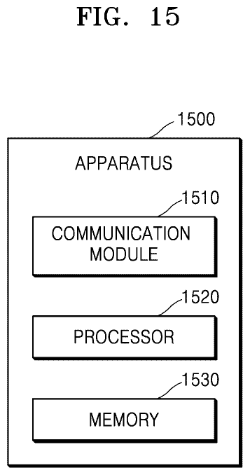

FIG. 15 is a block diagram of an apparatus according to an embodiment. The apparatus 1500 illustrated in FIG. 15 may correspond to the generation device 100 illustrated in FIG. 1.

Referring to FIG. 15, the apparatus 1500 may include a communication module 1510, a processor 1520, and a memory 1530. In the apparatus 1500 of FIG. 15, only the components related to the embodiment are illustrated. Accordingly, it will be understood by those skilled in the art that the apparatus 1500 may further include other general components in addition to the components illustrated in FIG. 15.

The communication module 1510 may include at least one component that enables the apparatus 1500 to perform wired/wireless communication with another device. For example, the communication module 1510 may include a wired communication unit for implementing Ethernet, serial communication, or optical communication, and/or a wireless communication unit for implementing Wi-Fi, Bluetooth, or cellular network-based communication.

The apparatus 1500 may exchange information with other devices constituting the system 10 by performing wired communication and/or wireless communication using the communication module 1510.

The processor 1520 may control the overall operation of the apparatus 1500. For example, the processor 1520 may control the communication module 1510, the memory 1530, an input unit (not shown), and/or an output unit (not shown) in general by executing programs stored in the memory 1530. The processor 1520 may control the operation of the apparatus 1500 by executing programs stored in the memory 1530.

The processor 1520 may control at least some of the operations of the apparatus 1500 described above with reference to FIGS. 1 to 14. For example, the processor 1520 may control the communication module 1510 to generate, by using a pre-trained first language model, a call sequence based on an input text of a vehicle passenger, execute the call sequence, and thereby obtain information of interest, and generate an output text corresponding to the input text, based on the information of interest, by using a pre-trained second language model.

As another example, the processor 1520 may generate, by using a pre-trained language model, a first output text corresponding to an input text of a vehicle passenger, based on the input text of the vehicle passenger, and generate an interface that displays a call sequence used to generate the first output text.

An example of operation of the processor 1520 is the same as that described above with reference to FIGS. 1 to 14. Thus, a detailed description of the operation of the processor 1520 is omitted below.

The processor 1520 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The operations of at least some of the functional modules constituting the generation device 100, such as the first generation unit 110, the execution unit 120, and the second generation unit 130 illustrated in FIG. 3, etc., may be implemented by the processor 1520 performing computational processing corresponding to each functional module.

The memory 1530 may include hardware that stores various data processed within the apparatus 1500, and may store a program for various operations, processing and controlling of the processor 1520. The memory 1530 illustrated in FIG. 15 may be identical to the memory 101 illustrated in FIG. 3.

The memory 1530 may include random access memory (RAM) such as dynamic random-access memory (DRAM), static random-access memory (SRAM), read-only memory (ROM), electrically erasable programmable read-only memory (EEPROM), CD-ROM, Blu-ray or other optical disk storage, hard disk drive (HDD), solid state drive (SSD), or flash memory.

In an embodiment, the apparatus 1500 may be a mobile electronic device. For example, the apparatus 1500 may be implemented as a smartphone, a tablet PC, a PC, a smart TV, a personal digital assistant (PDA), a laptop, a media player, a device equipped with a camera, and other mobile electronic devices. Additionally, the apparatus 1500 may be implemented as a wearable device such as a watch, glasses, hair band, or ring having communication functions and data processing functions.

In another embodiment, the apparatus 1500 may be an electronic device embedded within a vehicle. For example, the apparatus 1500 may be an electronic device that is inserted into a vehicle during the vehicle production process or is combined with a vehicle through tuning after the production process.

In another embodiment, the apparatus 1500 may be a server located outside a vehicle. A server may be implemented by at least one computing device that communicates over a network to provide commands, codes, files, content, services, etc.

In an embodiment, a process performed in the apparatus 1500 may be performed by at least some of a mobile electronic device, an electronic device embedded within a vehicle, and a server located outside the vehicle.

An embodiment according to the present disclosure may be implemented in the form of a computer program that may be executed through various components on a computer, and the computer program may be recorded on a computer-readable medium. The medium may include, but is not limited to, magnetic media such as hard disks, floppy disks, and magnetic tapes, optical recording media such as CD-ROMs and DVDs, magneto-optical media such as floptical disks, and hardware devices specifically configured to store and execute program instructions, such as ROMs, RAMs, flash memory, and the like.

The computer program may be specially designed and configured for the present disclosure or may be known and available to those skilled in the art in the computer software field. Examples of the program instructions may include not only machine codes generated by using a compiler but also high-level language codes that may be executed on a computer by using an interpreter or the like.

According to an embodiment, the method according to various embodiments of the present disclosure may be provided as being included in a computer program product. The computer program product may be traded between sellers and buyers as commodities. The computer program product may be distributed in the form of a machine-readable storage medium (e.g., compact disc read only memory (CD-ROM)), or may be distributed online (e.g., by download or upload), via an application store (e.g., Play Store™), or directly between two user devices. In the case of online distribution, at least a portion of the computer program product may be temporarily stored or temporarily generated in a machine-readable storage medium, such as a memory of a manufacturer's server, an application store's server, or an intermediary server.

According to the present disclosure described above, by implementing generation of a call sequence used for generating a response of an interactive agent, by a single input/output process for a language model, the cost of using a language model may be reduced and the execution time of the interactive agent required for a response may be shortened.

In addition, according to the present disclosure, by implementing generation of a call sequence by a single input/output process for a language model, the types of calls constituting a call sequence and the structure of the call sequence may be optimized according to global optimum.

In addition, according to the present disclosure, by visualizing a call sequence used to generate a response of an interactive agent, a response generation process of the interactive agent may be intuitively conveyed to the user.

In addition, according to the present disclosure, by updating a call sequence used to generate a response of an interactive agent, based on user input, a user may manipulate the call sequence to obtain a desired response, thereby improving the interaction experience with the interactive agent.

The effects of the embodiments of the present disclosure are not limited to the effects mentioned above, and other effects not mentioned will be clearly understood by those skilled in the art from the description of this specification.

Unless there is an explicit description or contradiction of the order of the steps constituting the method according to the present disclosure, the steps may be performed in any appropriate order. The present disclosure is not necessarily limited to the order in which the above steps are described. The use of any and all examples, or exemplary language (e.g., “such as”) provided herein, is intended merely to better illuminate the present disclosure and does not pose a limitation on the scope of the present disclosure unless otherwise claimed. Furthermore, it will be obvious to those skilled in the art that various modifications, combinations, and variations may be made according to design conditions and factors within the scope of the appended claims or their equivalents.

Therefore, the present disclosure should not be limited to the embodiments described above, and not only the scope of the claims described below but also all scopes equivalent to or equivalently modified from the scope of the claims are included in the scope of the present disclosure.

What is claimed is:

1. A method of providing an interactive agent by using a call sequence, the method comprising:
generating a call sequence based on an input text of a vehicle passenger by using a first language model that is pre-trained;
obtaining information of interest by executing the call sequence; and
generating an output text corresponding to the input text, based on the information of interest, by using a second language model that is pre-trained,
wherein the call sequence comprises a plurality of calls.

2. The method of claim 1, wherein the call sequence comprises all calls for generating the output text.

3. The method of claim 1, wherein the call sequence comprises a plurality of calls having a nested structure.

4. The method of claim 1, wherein the generating of the call sequence further comprises preprocessing the input text based on at least one of entity search, dialogue example search, and prompt template application.

5. The method of claim 4, wherein the preprocessing comprises:
generating a first search result including an entity corresponding to at least one string constituting the input text, by using a previously generated entity database;
generating a second search result including at least one dialogue example having, with respect to the input text, a similarity higher than or equal to a threshold, by using a previously generated dialogue example database;
determining at least one call used in at least one dialogue example included in the second search result, as a target call; and
generating a first input prompt for the first language model by applying, to the input text, the first search result, and the target call, a first prompt template that is previously generated.

6. The method of claim 1, wherein the generating of the call sequence further comprises postprocessing an output of the first language model based on at least one of parsing and slot normalization.

7. The method of claim 6, wherein the postprocessing comprises:
generating a structured output representing a structure of the string by parsing the output of the first language model, which is a string representation; and
generating the call sequence by converting at least one string included in the structured output, into a normalized expression by using a slot normalization database that is previously generated.

8. The method of claim 1, wherein the obtaining of the information of interest comprises obtaining the information of interest by sequentially executing at least some of the plurality of calls in a preset order or by executing at least some of the plurality of calls in parallel.

9. The method of claim 8, wherein the obtaining of the information of interest comprises obtaining the information of interest by sequentially executing the plurality of calls based on a depth-first search technique.

10. The method of claim 1, wherein the generating of the call sequence further comprises generating the call sequence based on the input text and a dialogue history of the vehicle passenger.

11. The method of claim 10, wherein the generating of the output text further comprises generating the output text based on the input text and the information of interest.

12. The method of claim 11, wherein
the generating of the call sequence further comprises updating the dialogue history by adding the input text to the dialogue history, and
the generating of the output text comprises generating the output text based on the updated dialogue history and the information of interest.

13. The method of claim 12, wherein the generating of the output text comprises generating a second input prompt for the second language model by applying, to the updated dialogue history and the information of interest, a second prompt template that is previously generated.

14. An apparatus for providing an interactive agent by using a call sequence, the apparatus comprising:
a communication module configured to perform communication;
a memory storing at least one program; and
a processor configured to operate by executing the at least one program,
wherein the processor is further configured to:
generate a call sequence based on an input text of a vehicle passenger, by using a first language model that is pre-trained;
control the communication module to obtain information of interest by executing the call sequence; and
generate an output text corresponding to the input text based on the information of interest, by using a second language model that is pre-trained,
wherein the call sequence comprises a plurality of calls.

15. A computer-readable recording medium having recorded thereon a program for causing a computer to execute the method of claim 1.
